(19) United States
(12) Patent Application Publication
(10) Pub. No.: US 2012/0240151 A1
(43) Pub. Date: Sep. 20, 2012

(54) Synchronizing Interactive Digital Advertisements displayed on client devices with television commercials

(76) Inventor: Seth Daniel Tapper, New York, NY (US)

(21) Appl. No.: 13/422,081

(22) Filed: Mar. 16, 2012

Related U.S. Application Data
(60) Provisional application No. 61/453,160, filed on Mar. 16, 2011.

(51) Int. Cl. H04N 21/80

(52) U.S. Cl. 725/32

(57) ABSTRACT

A system for the real time detection of an advertisement on a particular television channel or in a video stream, the development of a probability that the user of a client device such as a laptop, tablet or mobile phone (other than the device displaying the television channel or video stream, e.g. a Television) is viewing that particular television channel or video stream and the real time provision of an associated interactive digital advertisement to the user's client device, such as a laptop, tablet or smart phone. The system is composed of a series of software processes running on computer servers. Such servers comprising a microprocessor, data base, input device and output device wherein said data base comprises computer readable instructions stored in fixed memory or other digital storage system and executable by said microprocessor.

### CROSS REFERENCE TO RELATED APPLICATIONS

This application claims priority to US provisional patent application “Mobile TV Ad Coordination”, Ser. No. 61/453,160, filed Mar. 16, 2011. Said application is incorporated herein by reference.

### FIELD OF INVENTION

The inventions described herein are in the field of advertising delivery to the World Wide Web, and into apps for computers, tablets and mobile phone devices.

### BACKGROUND

There is need for a way to coordinate interactive digital ads on client devices, such as laptops, tablets and mobile phones, to television commercials in video streams and on TV Channels. These synchronized advertisements are more effective for marketers and provide value for consumers.

### SUMMARY OF INVENTION

The Summary of the Invention is provided as a guide to understanding the invention. It does not necessarily describe the most generic embodiment of the invention or all species of the invention disclosed herein.

The inventions described herein comprise the real time detection of an advertisement on a particular television channel or in a video stream, the development of a probability that the user of a client device such as a laptop, tablet or mobile phone (other than the device displaying the television channel of video stream, e.g. a Television) is viewing that particular television channel or video stream, and the real time provision of an associated digital advertisement to the user's client device, such as a laptop, tablet or smart phone.

### BRIEF DESCRIPTION OF FIGURES

FIG. 1 illustrates a system for providing Interactive Digital Ads to a client device simultaneously with the client viewing corresponding ads on TV.

### DETAILED DESCRIPTION

The following detailed description discloses various embodiments and features of the invention. These embodiments and features are meant to be exemplary and not limiting.

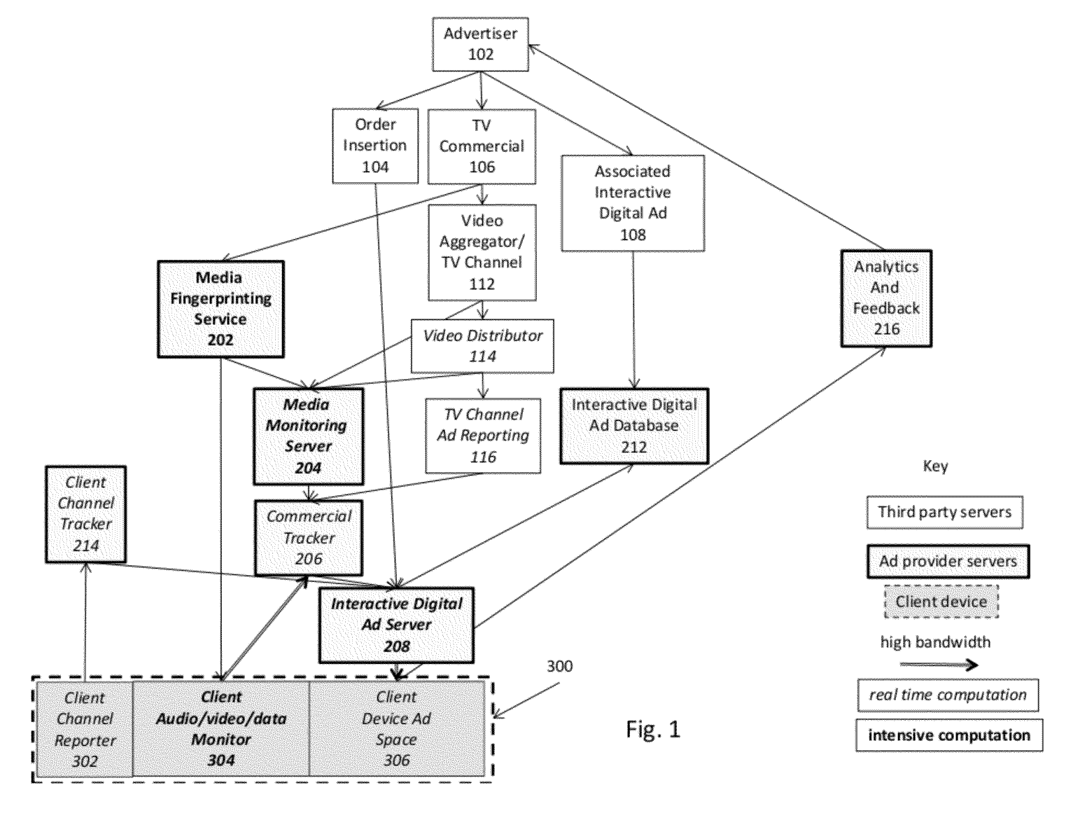

Mobile client devices, such as smart phones, tablets and laptops, are proliferating. These commonly communicate with remote devices, such as servers on the Internet, using local area networks, hard wire networks and/or cellular wireless telecommunications protocols, such as 3G and 4G. Many users of these client devices interact with them while they watch television channels or video streams on a second device (e.g. a Television). A user, for example, might use a website or app to vote for a contestant on a television program while watching that program. A client device may have one or more modules defined by their functionality. FIG. 1 illustrates three modules that a client device 300 may have according to the invention(s) described herein. The client device may comprise a Client Channel Reporter 302, a Client Audio/video/data Monitor 304 and a Client Device Ad Space 306. Other modules may be present as well. These modules will be discussed in more detail below.

Different advertisements are commonly broadcast with a television program. These advertisements are strictly one way communication. Information is broadcast to the users. If a user is interacting with a client device while said user is watching said broadcast program, however, there exists the opportunity to provide an interactive advertisement to the user that is coordinated with the presentation of a commercial on TV. These interactive second screen advertisements could include, but are not limited to, experiential brand information, in-depth product information, polling, interactive configuration of product options, link to review sites, request for demo appointment or sales call, and/or “buy now” functionality.

There are substantial technical challenges, however, to providing “Interactive Digital Ads” to a large number of client devices synchronized with television commercials in video streams or on TV Channels. These challenges include:
Problem A. identification of which commercial is being broadcast on a television channel or included in a video stream in real time.
Problem B. identifying what television channel or video stream the user of a client device is probably watching.
Problem C. matching the television commercial and user with the most effective digital ad.
Problem D. serving the correct interactive digital ads to the correct client devices in real time to match the television commercials.

FIG. 1 illustrates a system for solving problems A through D above. Boxes generally represent servers or data bases. Servers or data bases are digital computer based systems that comprise at least one microprocessor, one permanent memory wherein said memory is configured to provide instructions to said microprocessor, one input device and one output device wherein said instructions physically cause said microprocessor to transmit analog or digital content to a user from said output device in response to input from said input device. Said analog or digital output may comprise sounds transmitted by a speaker or images displayed on a monitor. Arrows in FIG. 1 represent transmission of analog or digital content. Double line arrows indicate high bandwidth requirements. Bold text indicates intensive computation. Italic text indicates real time computation.

An advertiser 102 creates a TV Commercial 106 and an Associated Interactive Digital Ad 108. Alternatively an Associated Interactive Digital Ad could be created by a third party with no affiliation to the creator of the television commercial, such as a competitor.

The TV Commercial is delivered to a Video Aggregator/TV Channel 112 (e.g. NBC, CBS, CNN) who also receives TV Commercials from other Advertisers. The Video Aggregator then inserts the TV Commercials in the appropriate TV programs and then broadcasts the programs over the air, publishes video streams of the programs over the Internet or provides a video feed of the programming, including the TV Commercials, to a Video Distributor 114, such as a satellite or Cable TV company, who in turn distributes the programming to consumers (not shown). The Video Distributor may also receive television commercials directly from advertisers and insert them into the video programming. These television commercials directly from advertisers are commonly referred to as Cable avails or Local avails.

### Problem A.

Problem A is the identification of which TV Commercial is being broadcast on a television channel or included in a video stream in real time. The system described by FIG. 1 displays three possible solutions to problem A. The system described can use any of these solutions alone or in any combination.

Problem A. Solution 1. Server Side Finger Printing

The TV Commercial is reported to a Media Fingerprinting Service 202 prior to inclusion in the video programming. A fingerprint of the audio/video/data track of the TV Commercial (where data might mean mpeg stream info, closed caption, or other sideband data) is generated. Fingerprinting technologies such as perceptual hashing and luminance matching are suitable.

A Media Monitoring Server 204 receives video programming from either a Video Aggregator 112 or a Video Distributor 114. The Media Monitoring Server examines this media stream and checks it against a reference file or database of TV Commercial fingerprints previously received from the Media Fingerprinting Service 202. When the Media Monitoring Server identifies a TV Commercial, it reports the identity of the TV Commercial currently playing in a given stream to a Commercial Tracker 206.

Problem A. Solution 2. Client Side Audio Finger Printing

Alternatively, a Client Audio Monitor 304 resident on a client device 300 may use the microphone of the client device to sample and fingerprint the audio of a media stream playing on another device (e.g. a Television or other media presentation system), in proximity to said client device. The Client Audio Monitor could either match the fingerprint to a reference file or database of media fingerprints resident on the client device or send the fingerprint to a server with such reference files or databases (not shown). When a Client Audio Monitor identifies a TV Commercial, it reports the identity of the TV Commercial currently playing in a given stream or TV Channel to the Commercial Tracker 206.

Problem A. Solution 3. Server to Server TV Spot Reporting by Video Aggregator and or Video Distributor

Alternatively, the “play out” computer system that inserts TV Commercials at the Video Aggregator 112 or the Video Distributor 114 could notify, via a server to server message, such as a JSON structure or other digital information structure, the Commercial Tracker 206 of the identity of the TV Commercial currently playing in a stream or on a TV Channel.

### Problem B.

Once the Commercial Tracker is informed that a particular TV Commercial is playing in a stream or on a TV Channel, the system must determine the probability that the user of a client device is watching said video stream or TV Channel. This is problem B.

The system described by FIG. 1 displays seven possible solutions to problem B. The system described can use any of these solutions alone or in any combination.

Problem B. Solution 1. Client Software Reports the Channel/Stream a User is Probably Watching using Audio Sampling

The Client Audio Monitor 304 may use the microphone of the client device to sample and fingerprint the audio of a video stream or TV Channel playing on another device (e.g. a Television) in proximity to the client device. The client device could either match the fingerprint to a reference file or database of media fingerprints resident on the client device or send the fingerprint to a server with such reference files or databases (not shown) in order to determine which channel or video stream the user is watching. When a client device identifies a stream or TV Channel a user is watching, it reports via a Client Channel Reporter 302, the identity of that stream or TV Channel to a Client Channel Tracker 214. A Client Channel Tracker comprises a server that keeps track of the channel or stream that the user of each client device is watching.

Problem B. Solution 2. Client Software Reports the Channel/Stream a User is Probably Watching using messaging from the TV or Set Top Box

Alternatively, the Client Channel Reporter could digitally communicate with the smart TV or set top box playing the stream or TV Channel a user is watching via HTTP, Bluetooth or other appropriate wireless or wired communication protocol. Once the device playing the stream or TV Channel, e.g. Smart Television or Set Top Box, reports the stream or channel a user is watching to the Client Channel Reporter, the Client Channel Reporter reports the identity of that stream or TV Channel to the Client Channel Tracker.

Problem B. Solution 3. Client Software Reports the Channel/Stream a User is Probably Watching because the client devices act as the Television/Cable Remote Control

Alternatively, the Client Channel Reporter could discover the identity of the stream or channel a user is watching by serving as a remote control and hence controlling the device playing the Video Stream or TV Channel, e.g. the Television. Once the Client Channel Reporter determines the identity of a stream of TV Channel a user is watching it reports the identity of that stream or TV Channel to the Client Channel Tracker.

Problem B. Solution 4. Client Software Reports the Channel/Stream a User is Probably Watching because the user is asked and or volunteers the information, e.g. “checks in” to a channel.

Alternatively, the Client Channel Reporter could know the identity of the stream or channel a user is watching because user of the client device volunteers the information by pressing a button, filling in a digital form or other appropriate input method. The user might be rewarded for volunteering this information in some way. Once the Client Channel Reporter determines the identity of a stream or TV Channel a user is watching it reports the identity of that stream or TV Channel to the Client Channel Tracker.

Problem B. Solution 5. Client Software Reports the Channel/Stream a User is Probably Watching because the user is interacting with content designed to be used while watching a program.

Alternatively, the Client Channel Reporter could determine, with a high level of probability, the identity of the stream or channel a user is watching because the user of the client device is interacting with content that is designed to be used while watching a specific program, stream or TV Channel. One example of this content is an app allowing a user to vote in real time for the best singer in a televised singing competition. Once the Client Channel Reporter determines the identity of a stream of TV Channel a user is probably watching it reports the identity of that stream or TV Channel to the Client Channel Tracker.

Problem B. Solution 6. Client Software Reports the Channel/Stream a User is Probably Watching because of information that the user is interested in or a fan of a show, video stream or TV Channel

Alternatively, software on the Client Channel Reporter could determine with a level of probability the identity of the stream or channel a user is watching because the Client Channel Reporter has access to information about the user that indicates that they are interested in, or a fan of, a program. This could include, but is not limited to, “following” feeds of the show, stream or TV Channel on Twitter or “liking” the show, stream or TV Channel on Facebook. Once the Client Channel Reporter determines the identity of a stream or TV Channel a user is probably watching it reports the identity of that stream or TV Channel to the Client Channel Tracker.

Problem B. Solution 7. Client Software Reports the Channel/Stream a User is Probably Watching because of information a user was recently watching the program from solution 1-6 above

Alternatively, the Client Channel Reporter could determine with a level of probability the identity of the stream or channel a user is watching because the user of the client has been marked (with a “browser cookie” or other digital profiling technique) as recently having, with some probability, been watching a particular show, stream or TV Channel. For instance, a user participating in a web experience for the Oscars during the Oscars could be cookied and then “retargeted” with Interactive Digital Ads if they navigate to unrelated websites while the Oscars broadcast is still on air. Once the Client Channel

Reporter determines the identity of a stream or TV Channel a user is probably watching it reports the identity of that stream or TV Channel to the Client Channel Tracker.

### Problem C.

Once the system described has identified a Television Commercial currently airing on a stream or TV Channel, stored that identity digitally in memory or on a disk on the Commercial Tracker 206, and determined which client devices have users that are watching said stream or TV Channel and hence said Television Commercial, the system must match an Interactive Digital Ad to said TV Commercial. This is problem C.

The system described by FIG. 1 displays two possible solutions to problem C. The system described can use any of these solutions alone or in any combination.

Problem C. Solution 1. Client Side Targeting

The system illustrated in FIG. 1 comprises a Interactive Digital Ad Server 208. The Interactive Digital Ad Server could do a “look up” which Interactive Digital Ad(s) are associated with a TV Commercial currently being played by querying an Interactive Digital Ad Database 212 using the ID of the TV Commercial currently airing as reported by the Commercial Tracker 206. The Interactive Digital Ad Database returns a set of one or more URLs that indicate the Internet location(s) of the Interactive Digital Ad(s) associated with said TV Commercial. Each URL may have accompanying “targeting information” defining the demographic and psychographic profiles of which users to display each Interactive Digital Ad to. The Interactive Digital Ad Server could then distribute (in a manner described in the section below labeled “Problem D”) to the client software controlling each Client Device Ad Space 306 one or more URLs that indicate the Internet location(s) of Interactive Digital Ad(s) as reported by the Interactive Digital Ad Database. Each URL distributed may have accompanying “targeting information” defining the demographic and psychographic profiles of which users to display each Interactive Digital Ad to.

The client software controlling each Client Device Ad Space could use demographic and/or psychographic information it has developed on the user of the client device to select one of the URLs distributed by the Interactive Digital Ad Server based on the accompanying “targeting information”. The software on the client device that controls Client Device Ad Space will then execute/display the contents of the files located at the selected URL. Said demographic and/or psychographic information could be obtained, for example, by requiring a user to answer questions to register on the client device,

Problem C. Solution 2. Ad Server Targeting

Alternatively, the system's Interactive Digital Ad Server could do a “look up” in the Interactive Digital Ad Database using the ID of the TV Commercial currently airing as reported by the Commercial Tracker. The Interactive Digital Ad Database could return one URL that points to a location on an Internet Advertising Server (such as a DoubleClick for Professionals platform, Ad Marvel or an Open X implementation) affiliated with the TV Commercial. The Interactive Digital Ad Server could then distribute (in a manner described in the section of this description labeled Problem D) to the client software controlling each Client Device Ad Space, the Ad Server URL as reported by the Interactive Digital Ad Database. The client software controlling each Client Device Ad Space could append demographic and or psychographic information it has developed on the user of the client device, by, for instance, requiring a user to answer questions to register on the client device, to the URL distributed by the Interactive Digital Ad Server based on a known Application Interface Protocol. The software on the client device that controls Client Device Ad Space will then make an HTTP call to the Internet Ad Server using the appended URL. The Internet Ad Server will then use an algorithm to select a URL that is both affiliated with the TV Commercial and may be targeted at the particular demographic and or psychographic profile of the user, and return that URL to the software on the client device that controls Client Device Ad Space. The software on the client device that controls Client Device Ad Space then executes/displays the contents of the files located at the URL returned by the Internet Ad Server.

### Problem D.

Most existing Digital Ad systems display ads when a user takes a particular action, e.g. loading a new web page, or upon set time sequences, e.g. rotating ads every two minutes. The system described herein requires Interactive Digital Ads to be displayed at times determined by the display of a Television Commercial on a different device (e.g. a Television). In order to display correct Interactive Digital Advertisements on the correct Client Device Ad Spaces on a time sequence not known in advance or set by software on the Client Device Ad Space, a new system for triggering and distributing Interactive Digital Advertisements is required. This is Problem D.

The system described by FIG. 1 displays two possible solutions to problem D. The system described can use any of these solutions alone or in any combination.

Problem D. Solution 1. Persistent Connection Ad Delivery

The software on a Client Device could open a persistent connection with a server allowing messages from the server to be “pushed” in real time to the client. Connections such as Comet, Socket or long polling are appropriate. The Client Device software could trigger the display of an Interactive Digital Advertisement upon receipt of a message from the server over this persistent connection. The message could either trigger an action by the client to “get” one or more URL's from the Interactive Digital Ad Server, or the message itself could include the URL from the Interactive Digital Ad Server.

Problem D. Solution 2. Frequent “Polling”

Alternately, the software on a Client Device could make a request on a set time schedule to determine if an Interactive Digital Ad affiliated with a TV Commercial that the user of the client device is likely watching is currently available to be displayed on the Client Device Ad Space. The time schedule for these requests must be sufficiently frequent that the Interactive Digital Advertisement will display in close proximity to the user of the Client Device viewing the affiliated TV Commercial. The Client Device software would trigger the display of an Interactive Digital Advertisement if, upon its request, a message is delivered that an Interactive Digital Ad affiliated with a TV Commercial that the user of the client device is likely watching is currently available.

Problem D. Solution 3. Server to Server Ad Delivery

The software on a Client Device may connect with a third party server (not shown) either through an open persistent connection, frequent polling or some other method. The Interactive Digital Ad Server could deliver triggering messages and Interactive Digital Advertisement URL's as defined in the section on Problem C to this third party server for redistribution to the software controlling the Client Device Ad Space.

### ALTERNATIVE EMBODIMENTS

The system may comprise a TV Channel Ad Reporting Server 116. Said server receives from a Video Distributor 114, identification of TV Commercials being played at a given time. This information is reported to a Commercial Tracker 206.

The system may comprise an Analytics and Feedback Server 216. Said server receives analytics and feedback from a client device 300 and aggregates and reports said data to an Advertiser 102.

### CONCLUSION

As used herein, the terms “about”, “approximately”, and their synonyms mean within plus or minus 10 percent of a given value, unless explicitly indicated otherwise or indicated otherwise by the context in which they are used.

While the disclosure has been described with reference to one or more different exemplary embodiments, it will be understood by those skilled in the art that various changes may be made and equivalents may be substituted for elements thereof without departing from the scope of the disclosure. In addition, many modifications may be made to adapt to a particular situation without departing from the essential scope or teachings thereof. Therefore, it is intended that the disclosure not be limited to the particular embodiment disclosed as the best mode contemplated for carrying out this invention.

1. A method for presenting an Interactive Digital Ad to a Client Device, said Interactive Digital Ad being associated with an advertisement being played in the presence of said Client Device, said method comprising the steps of:
a. the real time detection of said advertisement, said advertisement being played on a television channel or in a video stream;
b. the development of a probability that the user of said Client Device is viewing said television channel or video stream; and
c. the real time provision of said associated Interactive Digital Advertisement to said Client Device;
wherein said steps are carried out by at least one server in communication with said client device, said server comprising a microprocessor, a database, an input device and an output device and wherein said database comprises computer readable instructions stored in fixed memory or other digital storage system to cause said server to carry out said steps.

2. The method of claim 1 wherein said advertisement is a Television Commercial.

3. The method of claim 2 wherein said Television Commercial currently playing in a video stream or on a TV Channel is determined by Server Side Finger Printing.

4. The method of claim 2 wherein said Television Commercial currently playing in a video stream or on a TV Channel is determined by Client Side Audio Detection.

5. The method of claim 2 wherein said Television Commercial currently playing in a video stream or on a TV Channel is determined by Server to Server TV Spot Reporting by a Video Aggregator, a Video Distributor or the combination thereof.

6. The method of claim 1 wherein said Video Stream or TV Channel a User is Probably Watching is determined using client side Audio Sampling.

7. The method of claim 1 wherein said Video Stream or TV Channel a User is Probably Watching is determined using messaging from the TV or Set Top Box.

8. The method of claim 1 wherein said Video Stream or TV Channel a User is Probably Watching is determined because the client device acts as the Television/Cable Remote Control.

9. The method of claim 1 wherein said Video Stream or TV Channel a User is Probably Watching is determined because the user is asked or volunteers the information.

10. The method of claim 1 wherein the Video Stream or TV Channel a User is Probably Watching is determined because the user is interacting with content designed to be used while watching a program.

11. The method of claim 1 wherein the Video Stream or TV Channel a User is Probably Watching is determined because of information that the user is interested in or a fan of a show, video stream or TV Channel.

12. The method of claim 1 wherein the Video Stream or TV Channel a User is Probably Watching is determined because of information a user was recently watching a program on said Video Stream or TV Channel.

13. The method of claim 2 wherein said Interactive Digital Ad is matched to the currently playing TV Commercial in a video stream or TV Channel and to the demographic and or psychographic profile of the user of a client device by client side targeting.

14. The method of claim 2 wherein said Interactive Digital Ad is matched to the currently playing TV Commercial in a video stream or TV Channel and to the demographic and or psychographic profile of the user of a client device by Ad Server targeting.

15. The method of claim 1 wherein said Interactive Digital Ad is served to the correct client devices in real time to match the playing of a television commercial in a video stream of TV Channel by a method of persistent server connection.

16. The method of claim 1 wherein said Interactive Digital Ad is served to the correct client devices in real time to match the playing of a television commercial in a video stream of TV Channel by a method of frequent polling.

17. The method of claim 1 wherein said Interactive Digital Ad is served to the correct client devices in real time to match the playing of a television commercial in a video stream of TV Channel by a method of server to server ad delivery.

18. A system for presenting an Interactive Digital Ad to a Client Device, said Interactive Digital Ad being associated with an advertisement being played in the presence of said Client Device, said system comprising a microprocessor, a database, an input device and an output device and wherein said database comprises computer readable instructions stored in fixed memory or other digital storage system to cause said server to carry out the steps of:
a. the real time detection of said advertisement, said advertisement being played on a television channel or in a video stream;
b. the development of a probability that the user of said Client Device is viewing said television channel or video stream; and
c. the real time provision of said associated Interactive Digital Advertisement to said Client Device;
wherein said server is in communication with said Client Device.
